(19) United States
(12) Patent Application Publication
(10) Pub. No.: US 2014/0266129 A1
(43) Pub. Date: Sep. 18, 2014

(54) Method and System for Regulating Battery Voltages in Handheld/Portable Electronic Systems

(71) Applicant: Matthew Gilbert Clark, Topsham, ME (US)

(72) Inventor: Matthew Gilbert Clark, Topsham, ME (US)

(73) Assignee: DELORME PUBLISHING CO, Yarmouth, ME (US)

(21) Appl. No.: 14/209,412

(22) Filed: Mar. 13, 2014

Related U.S. Application Data
(60) Provisional application No. 61/779,651, filed on Mar. 13, 2013.

(51) Int. Cl. H02M 3/04

(52) U.S. Cl. CPC H02M 3/04
USPC 323/304

(57) ABSTRACT

A power supply circuit (1) for powering a load device (10) with the requirements of a high power burst at a low duty cycle. The power circuitry includes; a power source (2), a voltage comparator (3) which makes sure that the power source has enough power for the system, a series boost regulator (5) which delivers a higher voltage to the capacitor (7), a switching buck/boost regulator (8) which receives the voltage from the capacitor and regulates the higher or lower voltage to the load device.

### FIELD OF THE INVENTION

The invention relates to the field of battery voltage regulation in portable/handheld electronic systems with high power, low duty cycle current requirements.

### BRIEF SUMMARY OF INVENTION

Most mobile devices use some type of battery supply for powering the device. In the case of mobile communication devices the circuitry has to handle a wide variety of input voltages and be cable of supplying large surge currents for short periods of time. The prior art is to have a capacitor of sufficient capacity and minimal ESR (Equivalent Series Resistance) to deliver the surge needed by the transmission device for a short period of time. This invention describes a system which both reduces the capacitor requirements and increases the runtime of the different types of batteries while still supplying the necessary voltage and current to the transmission device.

### BRIEF DESCRIPTION OF THE DRAWINGS

FIG. 1 is a schematic representation of the power circuit according to the preferred embodiment of the invention.

### DESCRIPTION OF THE INVENTION

In the preferred embodiment on the invention a handheld and field-portable tracking and messaging device called the DeLorme inReach relies on 2 AA batteries to provide power to the electronics. The tracking and messaging device is referred to hereinafter simply as the inReach. The use of AA batteries is particularly desirable, because they are light weight, inexpensive, readily available around the world, and replaceable in the field. The electronic design challenge for the inReach is that the battery voltage can vary widely (from 1.8 V to 3.4 V) across different battery types (Alkaline, Nickel Metal Hydride, or Lithium). Also, the battery voltage changes over time as the batteries discharge and ambient temperature changes. The inReach circuitry however requires that the batteries provide large surge currents for short periods of time to the transmission device.

The inReach uses the Iridium Satellite System as its communication network and has an Iridium modem as the transmission device, in order to transmit and receive data to the Iridium satellites. During data transmission, the Iridium modem requires a short burst of consistent high power from the power supply. The difficulty with standard AA batteries is that they have an ESR which creates a drop in voltage during periods of high current draw. Depending on the type of batteries used and the ambient temperature, the batteries would have to be replaced before fully depleting the battery capacity.

The Iridium modem requires an operating voltage of 4.5 V to 5.5 V with 100 mV of maximum ripple during a message transmission. An Iridium message transmission requires as much as 2 amps of current at 5 V (10 Watts) for 8.3 ms. This surge repeats every 90 ms. If the Iridium modem were to be powered from a boost regulator straight from the AA batteries, the batteries would not be able to deliver the 10 W peak power while maintaining the required operating voltage range.

The inReach power supply circuit (1) solves this problem. The batteries (2) are boosted to a higher voltage (6) (5.3 V) using a series boost regulator (5). The voltage comparator (3) makes sure that the batteries have enough voltage to run the series boost regulator. If it does not the boost regulator is shut down (4) until the battery voltage is sufficient. The series boost regulator output is connected to a super capacitor (6), which has sufficient ESR and capacitance for energy storage. By boosting the capacitor voltage, energy storage is maximized. The super capacitor is also connected to a switching buck/boost regulator (8) which regulates the voltage (9) to the transmission device (10) to a voltage that can be above or below the boosted voltage while isolating the capacitor's ESR for the transmission device. The transmission device can be. In preferred embodiment this device is an Iridium modem but this device can be any load device that has a high power, low duty cycle current requirement.

By using a buck/boost regulator, energy from the capacitor can be delivered over a wide voltage range (from 5.3 V to 1.8 V) while maintaining low output ripple. In this configuration, the bulk of the surge current is delivered by the capacitor. The batteries both supplement the current surge as well as recharge the capacitor between surges.

The invention claimed is:

1. A power system which requires a low duty cycle, high power surge comprising of a power source, a voltage comparator, a series boost regulator, a capacitor, a switching buck/boost regulator and a load device.

2. A power system according to claim 1 wherein the power source voltage varies from 1.8 V to 3.4 V.

3. A power system according to claim 1 wherein the power source supplements the current surge as well as recharges the capacitor.

4. A power system according to claim 1 wherein a voltage comparator makes sure that the power source has enough power to run the series boost regulator.

5. A power system according to claim 1 wherein a series boost regulator connected in series with the voltage comparator and the capacitor is always supplying a higher voltage to the capacitor.

6. A series boost regulator according to claim 5 that maintains a minimal ESR (Equivalent Series Resistance) to the capacitor.

7. A power system according to claim 1 wherein the capacitor has the capacity to store the energy needed by the load device over a short period of time.

8. A power system according to claim 1 wherein a switching buck/boost regulator connected in series with the capacitor and the load device is regulating the voltage to the load device.

9. A switching buck/boost regulator according to claim 8 supplies a constant voltage to the load device during high voltage demands.

10. A switching buck/boost regulator according to claim 8 supplies a constant voltage to the load device during low duty cycles.

11. A switching buck/boost regulator according to claim 8 that maintains a minimal ESR (Equivalent Series Resistance) to the load device.

12. A power system according to claim 1 wherein a load device is a device that has a high power, low duty cycle current requirement.
